(19) United States
(12) Patent Application Publication
(10) Pub. No.: US 2010/0182310 A1
(43) Pub. Date: Jul. 22, 2010

(54) Display-driver data line driving device

(75) Inventor: Kazuo Nakamura, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/654,959

(22) Filed: Jan. 11, 2010

(30) Foreign Application Priority Data
Jan. 16, 2009 (JP) 2009-007827

(51) Int. Cl. G06F 3/038

(52) U.S. Cl. 345/214

(57) ABSTRACT

A display-driver data line driving device includes a multichannel shift resistor and divided data lines to accommodate a display panel with various levels of resolution and reduce power consumption. The data line driving device includes a first display latch portion (L1 to L6) latching data supplied via a divided data line DL1 with a shift pulse outputted from a first shift resistor (S1 to S6), a second display latch portion (L7 to L12) latching data supplied via a divided data line DL2 with a shift pulse outputted from a second shift resistor (S7 to S12), a third shift resistor 21 sending a shift pulse shifted by the first shift resistor to the second shift resistor, and selector circuits changing a channel between the first shift resistor and the third shift resistor 21 and a channel between the third shift resistor 21 and the second shift resistor. The third shift resistor is used to control the start and stop of the drive of the data lines.

### TECHNICAL FIELD

### Reference to Related Application

This application is based upon and claims the benefit of the priority of Japanese patent application No. 2009-007827, filed on Jan. 16, 2009, the disclosure of which is incorporated herein in its entirety by reference thereto.

The present invention relates to a display-driver data line driving device. In particular, the present invention relates to a data line driving device that supplies display data to source drivers of a matrix-type display device such as a thin film transistor liquid crystal display (TFT-LCD) device.

### BACKGROUND

In the field of general-purpose display driver ICs used in TFT-LCD devices or the like, in order to accommodate display panels with various levels of resolution, there has conventionally been a demand for display drivers in which the number of output channels can be selected and used.

Recently, display drivers in which the number of outputs can be selected from among six, eight, or more choices are being demanded, and there are also demanded such display drivers in which the difference between a maximum number of outputs and a minimum number of outputs exceeds 200.

FIG. 8 is a block diagram of a conventional display-driver multichannel shift resistor disclosed in FIG. 6 of Patent Document 1. Flip flops 610 to 670 sequentially shi a start signal SP in synchronization with a clock signal CLK toward an output signal SEQ of the flip flop 670. Output signals OUT and OUTB of each of the flip flops output shift pulses for latching data supplied via data buses, and display latches (not shown) use the signals OUT and OUTB as latch clocks and latch display data. These flip flops are supplied with control signals A, B, and C. When the number of output channels is decreased, these control signals A, B, and C shift and send a shift pulse via a bypass line 680 or 690 to a flip flop at a subsequent stage; that is, the shift pulse is not shifted through all the flip flops.

Aside from this, to increase the speed of a display driver and reduce the power consumption thereof, there is known a technique for dividing a data bus of a display driver into a plurality of portions and reducing the load of the data bus. FIG. 9 is a block diagram of a conventional display driver IC including divided data lines disclosed in Patent Document 2. Based on the driver IC shown in FIG. 9, data (analog signal) supplied from a central part of the driver IC is supplied via a switch SWd to data lines A and B divided on the left and right sides, respectively. The switch SWd is controlled by a control signal CONT generated from a control signal generation circuit 111. The control signal generation circuit 111 generates the control signal CONT based on shift resistors SR1 to SRn included in the driver IC (n is the number of outputs of a single driver IC).

When the resistor SR1 receives a start pulse STH, the shift resistors SR1 to SRn sequentially output shift pulses SRO1 to SROn based on a clock. The signal outputted from the resistor SRn is used as a start pulse STH for another diver IC connected at the next stage.

The data line A is connected to switches SW1 to SWn/2, and sample-and-hold circuits S/H1 to S/Hn/2 are connected to the data line A via the switches SW1 to SWn/2, respectively. Signals from the sample-and-hold circuits S/H1 to S/Hn/2 are outputted from the driver IC via a voltage-follower output amplifier unit 112.

Patent Document 1: Japanese Patent Kokai Publication No. 2006-72368 A (FIG. 6)

Patent Document 2: Japanese Patent Kokai Publication No. 2000-250495 A (FIG. 1)

### SUMMARY

The entire disclosures in the above-mentioned Patent Documents 1 and 2 are incorporated herein by reference thereto.

Even a display driver in which the number of display channels can be selected by using a multichannel shift resistor as disclosed in Patent Document 1 needs to be improved in speed and power consumption by dividing a data line as disclosed in Patent Document 2. However, when a display driver using a multichannel shift resistor and divided data lines are combined, timings at which the drive of the divided data lines is started and stopped need to be controlled. To drive a data line at high speed, the drive of the data line needs to be started shortly before data supplied via the divided data line is latched. In this case, depending on selection of the number of display channels, the data line drive timing also needs to be changed. Thus, there is a demand for a display-driver data line driving circuit comprising a simple circuit for changing the drive timings of the divided data lines depending on selection of the number of display channels.

A display-driver data line driving device according to a first aspect of the present invention comprises a first data line driving circuit that drives a first data line, a first shift resistor, a first display latch portion that is connected to the first data line and that receives a shift pulse shifted by the first shift resistor as a clock to latch data supplied via the first data line, a second data line driving circuit that drives a second data line, a second shift resistor, a second display latch portion that is connected to the second data line and that receives a shift pulse shifted by the second shift resistor as a clock to latch data supplied via the second data line, a third shift resistor that is arranged between the first shift resistor and the second shift resistor and that sends a shift pulse shifted by the first shift resistor to the second shift resistor as a shift pulse; and selector circuits that change a channel through which a shift pulse is supplied from the first shift resistor to the third shift resistor and a channel through which a shift pulse is supplied from the third shift resistor to the second shift resistor. The first data line driving circuit stops driving the first data line based on a shift pulse shifted by the third shift resistor, and the second data line driving circuit starts driving the second data line based on a shift pulse shifted by the third shift resistor.

A display-driver data line driving device according to a second aspect of the present invention comprises a first data line driving circuit that drives a first data line, a first shift resistor, a first display latch portion that is connected to the first data line and that receives a shift pulse shifted by the first shift resistor as a clock to latch data supplied via the first data line, a second data line driving circuit that drives a second data line, a second shift resistor, a second display latch portion that is connected to the second data line and that receives a shift pulse shifted by the second shift resistor as a clock to latch data supplied via the second data line, a first channel and a second channel that send a shift pulse shifted by the first shift resistor to the second shift resistor as a shift pulse; and selector circuits that select whether to input a shift pulse shifted by the first shift resistor to the second shift resistor via the first channel or the second channel. The first data line driving circuit stops driving the first data line after the first display latch portion latches data, and the second data line driving circuit starts driving the second data line before the second display latch portion latches data.

According to the present invention, there is provided a display-driver data line driving device including a multichannel shift resistor and divided data lines, and since the drive timings of the data lines can be controlled depending on the number of display channels, consumption power can be reduced.

The above features and advantages of the present invention will be more apparent from the following description taken in conjunction with the accompanying drawings.

### BRIEF DESCRIPTION OF THE DRAWINGS

FIG. 1 is a block diagram of a display-driver data line driving circuit according to exemplary embodiment 1 of the present invention.

FIG. 2 is a block diagram of a source driver portion according to exemplary embodiment 1 of the present invention.

FIG. 3 is a timing diagram illustrating an operation when the number of display channels is small according to exemplary embodiment 1 of the present invention.

FIG. 4 is a timing diagram illustrating an operation when the number of display channels is large according to exemplary embodiment 1 of the present invention.

FIG. 5 is a block diagram of a display-driver data line driving circuit according to exemplary embodiment 2 of the present invention.

FIG. 6 is a timing diagram illustrating an operation when the number of display channels is small according to exemplary embodiment 2 of the present invention.

FIG. 7 is a timing diagram illustrating an operation when the number of display channels is large according to exemplary embodiment 2 of the present invention.

FIG. 8 is a block diagram of a conventional display-driver multichannel shift resistor disclosed in Patent Document 1.

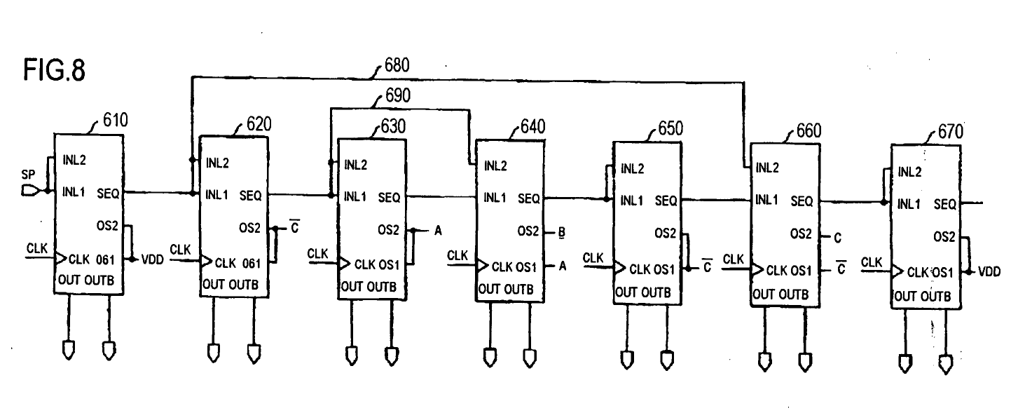

FIG. 9 is a block diagram of a conventional display driver IC comprising divided data lines disclosed in Patent Document 2.

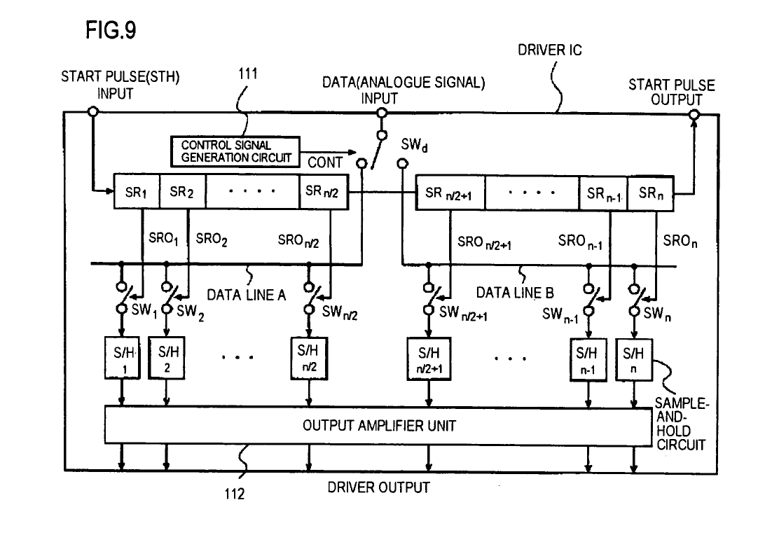

### PREFERRED MODES

Summary of exemplary embodiments of the present invention will be described with reference to the drawings as needed.

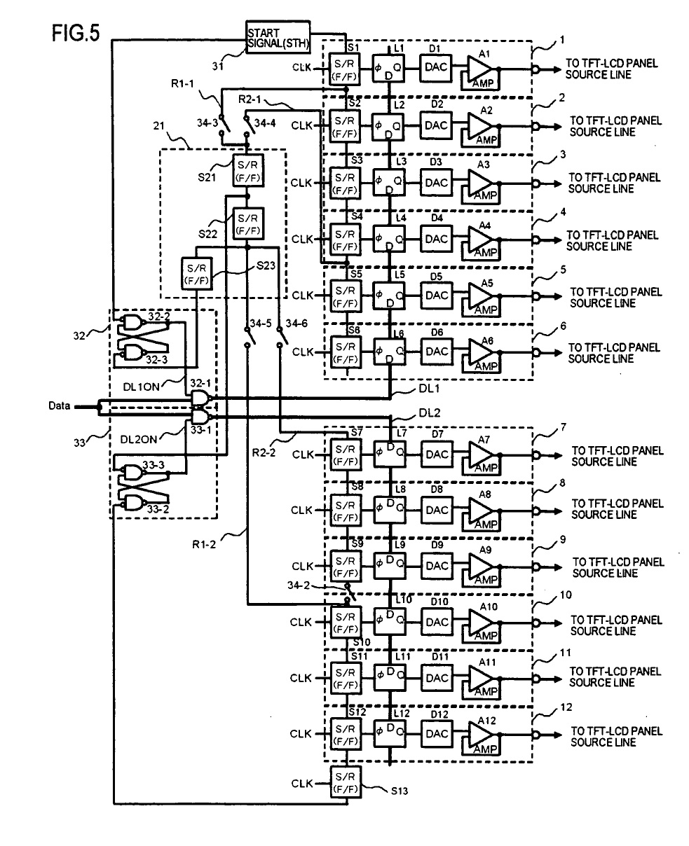

As shown in FIG. 5, a display-driver data line driving device according to one exemplary embodiment of the present invention comprises a first data line driving circuit 32 that drives a first data line DL1, a first shift resistor (S1 to S6), a first display latch portion (L1 to L6) that is connected to the first data line DL1 and that receives a shift pulse shifted by the first shift resistor (S1 to S6) as a clock φ to latch data supplied via the first data line DL1, a second data line driving circuit 33 that drives a second data line DL2, a second shift resistor (S7 to S13), a second display latch portion (L7 to L12) that is connected to the second data line DL2 and that receives a shift pulse shifted by the second shift resistor (S7 to S13) as a clock φ to latch data supplied via the second data line DL2, a third shift resistor 21 that is arranged between the first shift resistor (S1 to S6) and the second shift resistor (S7 to S13) and that sends a shift pulse shifted by the first shift resistor (S1 to S6) to the second shift resistor (S7 to S13) as a shift pulse; and selector circuits (34-2 to 34-6) that change a channel through which a shift pulse is supplied from the first shift resistor (S1 to S6) to the third shift resistor 21 and a channel through which a shift pulse is supplied from the third shift resistor 21 to the second shift resistor (S7 to S13). The first data line driving circuit 32 stops driving the first data line DL1 based on a shift pulse (an output from a data flip flop S23) shifted by the third shift resistor 21, and the second data line driving circuit 33 starts driving the second data line DL2 based on a shift pulse (an output from a data flip flop S21) shifted by the third shift resistor 21.

Based on the above configuration, since the third shift resistor 21 is arranged between the first shift resistor (S1 to S6) and the second shift resistor (S7 to S13) and the third shift resistor is used to control timings at which the drive of the data lines is started and stopped, even when the number of choices about the number of channels is increased, simply by changing a channel between the first shift resistor and the third shift resistor and a channel between the third shift resistor and the second shift resistor, the timings at which the drive of the data lines is started and stopped can be made optimum.

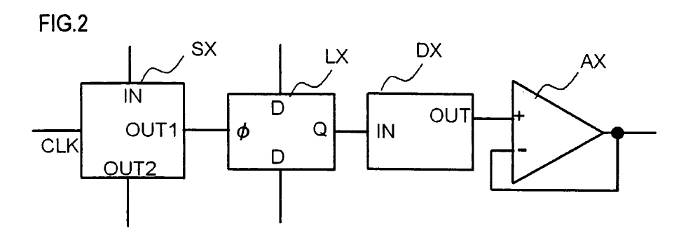

Further, as shown in FIGS. 2 and 5, based on the display-driver data line driving device according to one exemplary embodiment of the present invention, each of the first to third shift resistors (S1 to S6, S7 to S13, and 21) may comprise cascaded data flip flops (individual elements S1 to S6, S7 to S13, and S21 to S23). Each of the data flip flops (SX in FIG. 2) may comprise a data input terminal IN, a clock input terminal CLK, and data output terminals (OUT1 and OUT2) and output a shift pulse supplied via the data input terminal IN from the data output terminals (OUT1 and OUT2) in synchronization with a clock supplied via the clock input terminal CLK. The third shift resistor 21 may comprise a first data flip flop S21 and a second data flip flop S23 connected in a stage subsequent to the first data flip flop S21. The first data line driving circuit 32 may stop driving the first data line DL1 in synchronization with a shift pulse outputted from the second data flip flop S23, and the second data line driving circuit 33 may start driving the second data line DL2 in synchronization with a shift pulse outputted from the first data flip flop S21.

Further, as shown in FIG. 5, based on the display-driver data line driving device according to one exemplary embodiment of the present invention, the third shift resistor 21 may comprise a third data flip flop S22 connected in a stage subsequent to the first data flip flop S21 and prior to the second data flip flop S23, and a data output terminal of the third data flip flop S22 may be connected to the second shift resistor via the selector circuits (34-5 and 34-6).

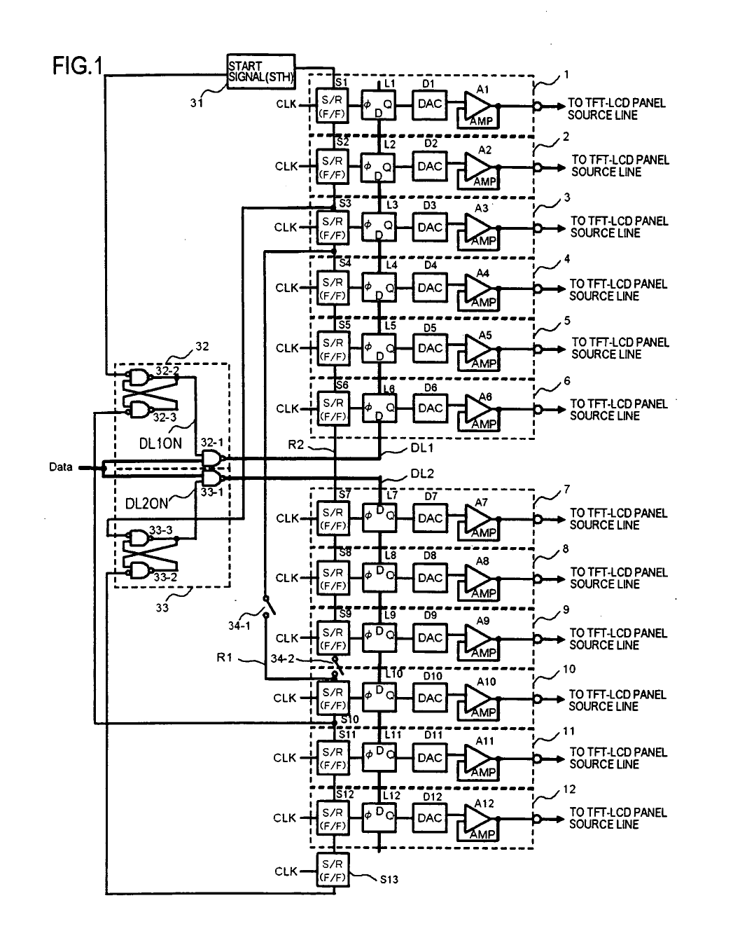

Further, as shown in FIGS. 1 and 5, a display-driver data line driving device according to one exemplary embodiment of the present invention comprises a first data line driving circuit 32 that drives a first data line DL1, a first shift resistor (S1 to S6), a first display latch portion (L1 to L6) that is connected to the first data line DL1 and that receives a shift pulse shifted by the first shift resistor (S1 to S6) as a clock to latch data supplied via the first data line DL1, a second data line driving circuit 33 that drives a second data line DL2, a second shift resistor (S7 to S13), a second display latch portion (L7 to L12) that is connected to the second data line DL2 and that receives a shift pulse shifted by the second shift resistor (S7 to S13) as a clock to latch data supplied via the second data line DL2, a first channel (R1; R1-1, R1-2) and a second channel (R2; R2-1, R2-2) that send a shift pulse shifted by the first shift resistor (S1 to S6) to the second shift resistor (S7 to S13) as a shift pulse; and selector circuits (34-1 to 34-6) that select whether to input a shift pulse shifted by the first shift resistor (S1 to S6) to the second shift resistor (S7 to S13) via the first channel (R1; R1-1, R1-2) or the second channel (R2; R2-1, R2-2). The first data line driving circuit 32 stops driving the first data line DL1 after the first display latch portion (L1 to L6) latches data, and the second data line driving circuit 33 starts driving the second data line DL2 before the second display latch portion (L7 to L12) latches data.

Based on the above configuration, since the drive of the first data line DL1 is stopped after the first display latch portion (L1 to L6) latches data and the drive of the second data line DL2 is started before the second display latch portion (L7 to L12) latches data, even when a multichannel shift resistor is used to change the number of display channels, a data line can be divided. Thus, high-speed operation and low power consumption can be achieved.

Further, as shown in FIGS. 1, 2, and 5, based on the display-driver data line driving device according to one exemplary embodiment of the present invention, each of the first and second shift resistors (S1 to S6 and S7 to S13) may comprise cascaded data flip flops (individual elements S1 to S13). Each of the data flip flops (SX in FIG. 2) may comprise a data input terminal IN, a clock input terminal CLK, and data output terminals (OUT1 and OUT2) and output a shift pulse supplied via the data input terminal IN from the data output terminals (OUT1 and OUT2) in synchronization with a clock supplied via the clock input terminal CLK. The second data line driving circuit 33 may start driving the second data line DL2 in synchronization with a shift pulse outputted from a data flip flop (S2 or S21) arranged in a stage prior to the selector circuits (34-1, 34-2, 34-5, 34-6). The first data line driving circuit 32 may stop driving the first data line DL1 in synchronization with a shift pulse that is further delayed by causing the data flip flop (S10 or S23) to shift a shift pulse supplied to the second shift resistor (S7 to S13) via the selector circuits (34-1, 34-2, 34-5, 34-6).

Namely, based on the above configuration, irrespective of selection about the number of display channels, common circuits can be used to generate a timing to start driving the second data line and a timing to stop driving the first data line.

Furthermore, as shown in FIGS. 1 and 5, based on the display-driver data line driving device according to one exemplary embodiment of the present invention, the first data line driving circuit 32 may start driving the first data line DL1 based on a start signal STH supplied as a shift pulse to an initial stage of the first shift resistor (S1 to S6), and the second data line driving circuit 33 may stop driving the second data line DL2 based on a shift pulse outputted from a final stage S13 of the second shift resistor (S7 to S13).

Each of the exemplary embodiments will be hereinafter described in detail with reference to the drawings.

### Exemplary Embodiment 1

FIG. 1 is a block diagram of a display-driver data line driving circuit according to exemplary embodiment 1 of the present invention. Source driver circuit blocks 1 to 12 are circuit blocks for driving source lines of a TFT liquid crystal panel. The source driver circuit blocks 1 to 6 are supplied with display data via a first data line DL1, and the source driver circuit blocks 7 to 12 are supplied with display data via a second data line DL2. A first data line driving circuit 32 drives the first data line DL1, and a second data line driving circuit 33 drives the second data line DL2.

FIG. 2 is a block diagram of a source driver unit, and an internal configuration of the source driver circuit blocks 1 to 12 will be described with reference to FIG. 2. Each of the source driver circuit blocks 1 to 12 comprises a data flip flop SX, a display latch (data latch) LX, a digital-to-analog (DA) converter DX, and an output amplifier AX. A data flip flop SX synchronizes with a clock signal CLK, receives a shift pulse via a data input terminal IN, and outputs a delayed shift pulse from data output terminals OUT1 and OUT2. In the source driver circuit blocks 1 to 12, the data output terminal OUT2 of a data flip flop is connected to the data input terminal IN of a data flip flop at the next stage. A start signal STH inputted to a data flip flop S1 at an initial stage is synchronized with the clock CLK and is sequentially shifted to a data flip flop S13 at a final stage. Namely, the source driver circuit blocks 1 to 12 function as a shift resistor. The data output terminals OUT1 and OUT2 output in-phase output signals.

The data output terminal OUT1 of the data flip flop SX is connected to a clock signal input terminal φ of the display latch LX, which latches data supplied via a data line D in synchronization with the shift pulse outputted from the data flip flop SX. The latched display data is outputted from a terminal Q. The DA converter DX converts the display data outputted from the display latch LX into an analog signal. After converted into an analog signal, the display data is outputted from an OUT terminal of the DA converter DX and is then amplified by the voltage-follower output amplifier AX to drive a source line of the TFT liquid crystal panel.

Hereinafter, display latches (L1 to L6), which receive data via the first data line DL1, will be collectively referred to as a first display latch portion, and display latches (L7 to L12), which receive data via the second data line DL2, will be collectively referred to as a second display latch portion. Further, data flip flops (S1 to S6), which supply the first display latch portion with a shift pulse as a clock, will be collectively referred to as a first shift resistor, and data flip flops (S7 to S13), which supply the second display latch portion (L7 to L12) with a shift pulse as a clock, will be collectively referred to as a second shift resistor. Based on the above configuration, the display latches in the first and second display latch portions use the shift pulses supplied from the first and second shift resistors, respectively, and latch data supplied via the first and second data lines DL1 and DL2, respectively, in a time-division manner.

Further, the data line driving circuit of FIG. 1 has a function of a multi-channel shift resistor. Specifically, the data line driving circuit comprises selector circuits 34-1 and 34-2 for selecting whether to supply a shift pulse outputted from the data flip flop S6 at a final stage of the first shift resistor (S1 to S6) to the flip flop S7 at an initial stage of the second shift resistor (S7 to S13) as a shift pulse or whether to supply a shift pulse outputted from the data flip flop S3 of the first shift resistor to the data flip flop S10 of the second shift resistor as a shift pulse. When the selector circuit 34-1 turns on and the selector circuit 34-2 turns off, that is, when the number of source lines of a liquid crystal panel is small, the source driver circuit blocks 4 to 9 do not drive source lines corresponding thereto. Since the source driver circuit blocks 4 to 9 do not drive the corresponding source lines, the corresponding clocks are stopped, and as a result, power consumption can be reduced. On the other hand, when the selector circuit 34-2 turns on and the selector circuit 34-1 turns off, the source driver circuit blocks 1 to 12 drive all the source lines.

Further, since the data lines are separately driven by the first data line driving circuit 32 and the second data line driving circuit 33, load per data line can be reduced and data transfer rate can be increased. In addition, since data lines are not driven at timings when the drive thereof is not necessary, power consumption for driving the data lines is less. The first data line driving circuit 32 comprises a set-reset flip flop comprised of NAND circuits 32-2 and 32-3. The first data line driving circuit 32 starts driving the data line DL1 in synchronization with the start signal STH and stops driving the data line DL1 based on a shift pulse outputted from the data flip flop S10.

Namely, the first data line driving circuit 32 stops driving the data line DL1 by using a pulse that is further delayed than a shift pulse supplied to the second shift resistor via the selector circuits 34-1 and 34-2. Based on such configuration, even when any given channel of the multichannel shift resistor is selected by the selector circuits, the drive of the first data line driving circuit 32 is stopped after the first display latch portion captures data supplied via the first data line DL1.

Further, the second data line driving circuit 33 comprises a set-reset flip flop comprised of NAND circuits 33-2 and 33-3. The second data line driving circuit 33 starts driving the data line DL2 in synchronization with a shift pulse outputted from the data flip flop S2 and stops driving the data line DL2 based on a shift pulse outputted from the data flip flop S13. Namely, in synchronization with a shift pulse outputted from the data flip flop S2 located at a stage prior to the selector circuits 34-1 and 34-2, the second data line driving circuit 33 starts driving the second data line DL2. Based on such configuration, even when any given channel of the multichannel shift resistor is selected by the selector circuits, the drive of the second data line driving circuit 33 is started before the second display latch portion captures data supplied via the second data line DL2.

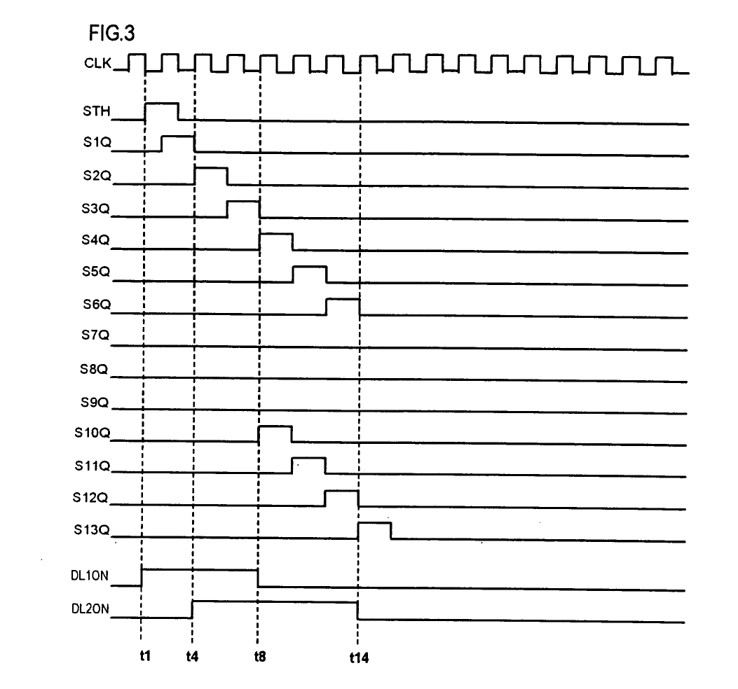

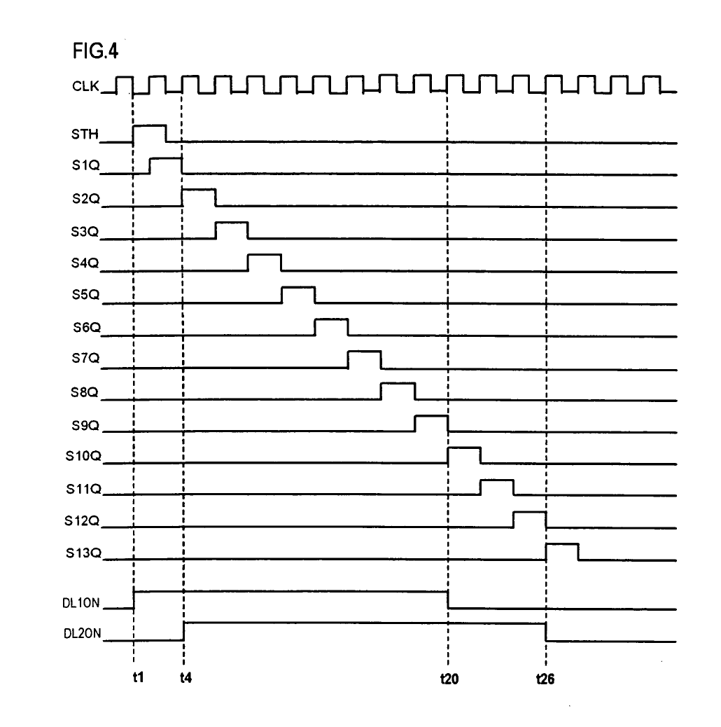

Next, data line drive operations will be described with reference to timing diagrams shown in FIGS. 3 and 4. FIGS. 3 and 4 are timing diagrams illustrating operations when the number of display channels is small and large, respectively.

First, the timing diagram shown in FIG. 3 will be described. FIG. 3 is a timing diagram illustrating an operation when the number of display channels is small, that is, when the selector circuits 34-1 and 34-2 in FIG. 1 are turned on and off, respectively. A shift pulse supplied as the start signal STH in synchronization with the clock signal CLK is sequentially shifted through the first shift resistor (S1 to S6). Since the data flip flop S3 of the first shift resistor supplies the shift pulse to the data flip flop S10 of the second shift resistor (S7 to S13), when a shift pulse outputted from the data flip flop S3 falls at timing t8, a shift pulse outputted from the data flip flop S10 rises. Among the flip flops forming the second shift resistor, the first three data flip flops S7 to S9 are not driven. Further, while the flip flops S4 to S6 are driven in the timing diagram of FIG. 3, these flip flops may be stopped.

A DL1ON is an output signal from the set-reset flip flop comprised of the NAND circuits 32-2 and 32-3, and the drive of the first data line DL1 is started or stopped based on the DL1ON. When the DL1ON is at a high level, the NAND circuit 32-1 outputs a data signal, and when the DL1ON is at a low level, the first data line DL1 is fixed at a high level. The DL1ON is set in synchronization with a rising edge of the start signal STH at timing t1 and reset in synchronization with a shift pulse outputted from the data flip flop S10 at the timing t8. Namely, the DL1ON starts driving the first data line DL1 half clock before a rising edge of S1Q, which is the latch clock of the display latch L1 that first latches data via the data line DL1 among the display latches (L1 to L6) of the first display latch portion. Further, the DL1ON stops driving the first data line DL1 in synchronization with a falling edge of S3Q, which is the latch clock of the display latch L3 that latches data via the data line DL1 last.

Further, a DL2ON is an output signal from the set-reset flip flop comprised of the NAND circuits 33-2 and 33-3, and the drive of the second data line DL2 is started or stopped based on the DL2ON. When the DL2ON is at a high level, the NAND circuit 32-1 outputs a data signal, and when the DL2ON is at a low level, the second data line DL1 is fixed at a high level. The DL2ON is set in synchronization with a shift pulse outputted from the data flip flop S2 at timing t4 and reset in synchronization with a shift pulse outputted from the data flip flop S13 at timing t14. Namely, the DL2ON starts driving the second data line DL2 two clocks before a rising edge of S10Q, which is the latch clock of the display latch L10 that first latches data via the data line DL2 among the display latches (L7 to L12) of the second display latch portion. Further, the DL2ON stops driving the second data line DL2 in synchronization with a falling edge of S12Q, which is the latch clock of the display latch L12 that latches data via the data line DL2 last.

Next, an operation when the number of display channels is large will be described with reference to the timing diagram of FIG. 4. FIG. 4 illustrates an operation when the selector circuits 34-2 and 34-1 in FIG. 1 are turned on and off, respectively. In FIG. 4, all the source driver circuit blocks 1 to 12 operate. A shift pulse supplied as the start signal STH in synchronization with the clock signal CLK is sequentially shifted through the first and second shift resistors (S1 to S13). The first stage of the second shift resistor is supplied with a shift pulse outputted from the final stage of the first shift resistor.

The DL1ON, which is a control signal that controls the start and stop of the operation of the first data line driving circuit 32, is set in synchronization with a rising edge of the start signal STH at timing t1, and accordingly, the first data line driving circuit 32 starts driving the first data line DL1. Further, the DL1ON is reset in synchronization with a shift pulse outputted from the data flip flop S10 at timing t20 and stops driving the first data line DL1. The timing at which the drive of the first data line DL1 is stopped is sufficiently after the timing at which display data is finally latched in synchronization with a shift pulse outputted from the data flip flop S6 in the first display latch portion (L1 to L6).

The DL2ON, which is a control signal that controls the start and stop of the operation of the second data line driving circuit 33, is set in synchronization with a shift pulse outputted from the data flip flop S2 at timing t4 and starts driving the second data line DL2. The DL2ON is reset in synchronization with a shift pulse outputted from the data flip flop S13 at timing t26 and stops driving the second data line DL2. The timing at which the drive of the second data line DL2 is started is sufficiently before the timing at which display data is first latched in synchronization with a shift pulse outputted from the data flip flop S7 in the second display latch portion (L7 to L12).

As described above, according to exemplary embodiment 1, in the display-driver data line driving circuit, the number of source lines to be driven can be selected by using a multichannel shift resistor and divided data lines. In addition, the start and stop of the drive of the divided data lines can be controlled by common circuits, irrespective of selection about the multichannel resistor.

### Exemplary Embodiment 2

FIG. 5 is a block diagram of a display-driver data line driving circuit according to exemplary embodiment 2. The circuits similar to those in exemplary embodiment 1 are denoted by the same reference characters, and the descriptions thereof will be omitted herein. In exemplary embodiment 2, between the first shift resistor (S1 to S6) and the second shift resistor (S7 to S13), there is arranged a third shift resistor 21 that sends a shift pulse shifted by the first shift resistor to the second shift resistor. A channel between the first shift resistor (S1 to S6) and the third shift resistor 21 is switched by selector circuits (34-3 and 34-4), and a channel between the third shift resistor 21 and the second shift resistor is switched by selector circuits (34-2, 34-5, and 34-6). Further, the third shift resistor is used to control a timing at which the first data line driving circuit 32 stops driving the first data line DL1 and a timing at which the second data line driving circuit 33 starts driving the second data line DL2.

A data flip flop S21 at an initial stage in the third shift resistor 21 receives a shift pulse outputted from the data flip flop S1 or S4 in the first shift resistor via the selector circuit 34-3 or 34-4. A shift pulse outputted from the data flip flop S21 at the initial stage in the third shift resistor 21 is inputted to the NAND circuit 33-3, and the second data line driving circuit 33 starts driving the second data line DL2 in synchronization with the shift pulse outputted from the data flip flop S21.

A data flip flop S22 at the second stage in the third shift resistor 21 supplies a shift pulse to the data flip flop S7 of the second shift resistor (S7 to S13) via a selector circuit 34-6 or to the data flip flop S10 via a selector circuit 34-5. Further, a shift pulse outputted from a data flip flop S23 at the third stage in the third shift resistor 21 is inputted to a NAND circuit 32-3, and the first data line driving circuit 32 stops driving the first data line DL1 in synchronization with the shift pulse outputted from the data flip flop S23.

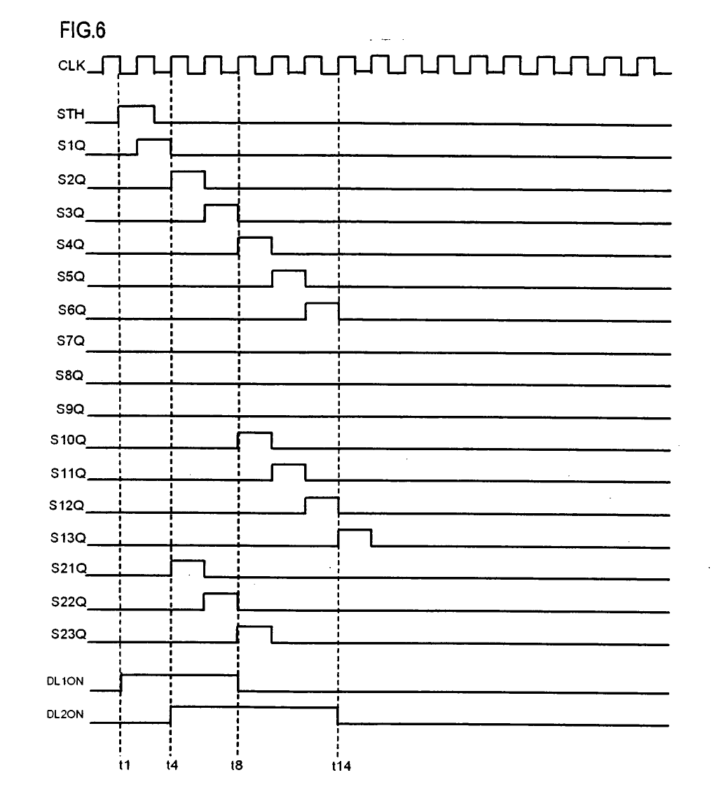

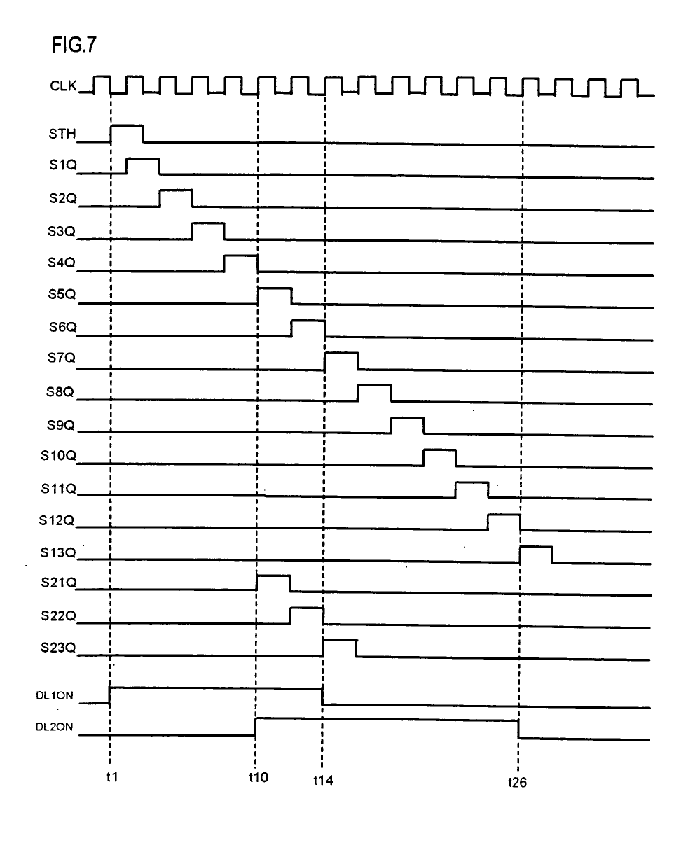

Next, an operation of this data line driving device will be described with reference to timing diagrams of FIGS. 6 and 7. FIGS. 6 and 7 are timing diagrams illustrating operations when the number of display channels is small and large, respectively. First, the timing diagram of FIG. 6 will be described. FIG. 6 is a timing diagram illustrating an operation when the number of display channels is small, that is, when the selector circuits 34-3 and 34-5 in FIG. 5 are turned on and the selector circuits 34-2, 34-4, and 34-6 in FIG. 5 are turned off. In FIG. 6, the data flip flop S21 of the third shift resistor 21 is synchronized with the flip flop S2 of the first shift resistor, and the data flip flop S23 is synchronized with the data flip flop S10 of the second shift resistor. Thus, operation timings shown in FIG. 3 according to exemplary embodiment 1 are the same as those shown in FIG. 6, except that the data flip flop S23, instead of S10, resets the control signal DL1ON and the data flip flop S21, instead of S2, sets the control signal DL2ON.

FIG. 7 is a timing diagram illustrating an operation when the number of display channels is large. Timings of FIG. 7 differ from those of FIG. 4, which is a timing diagram according to exemplary embodiment 1. FIG. 7 is a timing diagram illustrating an operation when the number of display channels is large; that is, when the selector circuits 34-2, 34-4, and 34-6 in FIG. 5 are turned on and the selector circuits 34-3 and 34-5 in FIG. 5 are turned off. In FIG. 7, the data flip flop S21 of the third shift resistor 21 is synchronized with the flip flop S5 of the first shift resistor, and the data flip flop S23 is synchronized with the data flip flop S7 of the second shift resistor. Thus, the DL1ON is reset at timing t14, and the DL2ON is set at timing t10 in FIG. 7.

Exemplary embodiment 1 is effective when the number of display channels is small. However, when the number of display channels is large, the timing at which the drive of the first data line DL1 is stopped is too late and the timing at which the drive of the second data line DL2 is started is too early. Thus, advantageous effects provided by dividing a data line and stopping the drive of unnecessary data lines cannot be sufficiently obtained. However, according to exemplary embodiment 2, the third shift resistor is provided between the first and second shift resistors, and the third shift resistor is used to control the timing at which the drive of the first data line DL1 is stopped and the timing at which the drive of the second data line DL2 is started. Thus, exemplary embodiment 2 has the advantage that the drive of the divided data lines can be started and stopped at optimum timings, regardless of the number of display channels.

Namely, as shown in the timing diagrams of FIGS. 3 and 4 according to exemplary embodiment 1, depending on the number of display channels, there is a difference in the period when both of the first and second data lines DL1 and DL2 drive (difference between FIGS. 3 and 4 in the period when the DL1ON and the DL2ON are both at a high level). However, as shown in the timing diagrams of FIGS. 6 and 7 according to exemplary embodiment 2, there is no difference in the period when both of the first and second data lines DL1 and DL2 drive (difference between FIGS. 6 and 7 in the period when the DL1ON and the DL2ON are both at a high level), irrespective of the number of display channels.

While the number of display channels can be selected with only two channels (a channel with R1-1 and R1-2 and a channel with R2-1 and R2-2) in the circuit of FIG. 5, by simply changing the connection channel between the first shift resistor and the third shift resistor and the connection channel between the third shift resistor and the second shift resistor, it becomes possible to increase the number of choices about the number of display channels to an arbitrary number. Even when the number of choices about the number of display channels is increased, optimum timings at which the drive of the data lines is started and stopped can be controlled without changing the circuit configuration of the third shift resistor 21 and the first and second data line driving circuits 32 and 33.

In addition, the period when both of the first and second data lines DL1 and DL2 drive is not limited to the above example based on the circuit of FIG. 5. The period can be arbitrarily changed by changing the number of stages in the third shift resistor.

In the present invention, there are various possible modes, which include:

(Mode 1) as set forth as the first aspect.
(Mode 2) The display-driver data line driving device according to mode 1,

wherein each of the first to third shift resistors comprises cascaded data flip flops, each of the data flip flops comprising a data input terminal, a clock input terminal, and data output terminals and outputting a shift pulse supplied via the data input terminal from the data output terminals in synchronization with a clock supplied via the clock input terminal,

wherein the third shift resistor comprises a first data flip flop and a second data flip flop connected in a stage subsequent to the first data flip flop,

wherein the first data line driving circuit stops driving the first data line in synchronization with a shift pulse outputted from the second data flip flop, and

wherein the second data line driving circuit starts driving the second data line in synchronization with a shift pulse outputted from the first data flip flop.

(Mode 3) The display-driver data line driving device according to mode 2, wherein the third shift resistor comprises a third data flip flop connected in a stage subsequent to the first data flip flop and prior to the second data flip flop, and a data output terminal of the third data flip flop is connected to the second shift resistor via the selector circuits.
(Mode 4) The display-driver data line driving device according to mode 1, wherein the first data line driving circuit starts driving the first data line based on a start signal supplied as a shift pulse to an initial stage of the first shift resistor, and the second data line driving circuit stops driving the second data line based on a shift pulse outputted from a final stage of the second shift resistor.
(Mode 5) as set forth as the second aspect.
(Mode 6) The display-driver data line driving device according to mode 5, wherein each of the first and second shift resistors comprises cascaded data flip flops, each of the data flip flops comprising a data input terminal, a clock input terminal, and data output terminals and outputting a shift pulse supplied via the data input terminal from the data output terminals in synchronization with a clock supplied via the clock input terminal

wherein the second data line driving circuit starts driving the second data line in synchronization with a shift pulse outputted from a data flip flop arranged in a stage prior to the selector circuits, and

wherein the first data line driving circuit stops driving the first data line in synchronization with a shift pulse that is further delayed by causing a data flip flop to shift a shift pulse supplied to the second shift resistor via the selector circuits.

(Mode 7) The display-driver data line driving device according to mode 1 to 6, wherein the first data line driving circuit starts driving the first data line based on a start signal supplied as a shift pulse to an initial stage of the first shift resistor, and the second data line driving circuit stops driving the second data line based on a shift pulse outputted from a final stage of the second shift resistor.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A display-driver data line driving device comprising:
a first data line driving circuit that drives a first data line;
a first shift resistor;
a first display latch portion that is connected to the first data line and that receives a shift pulse shifted by the first shift resistor as a clock to latch data supplied via the first data line;
a second data line driving circuit that drives a second data line;
a second shift resistor;
a second display latch portion that is connected to the second data line and that receives a shift pulse shifted by the second shift resistor as a clock to latch data supplied via the second data line;
a third shift resistor that is arranged between the first shift resistor and the second shift resistor and that sends a shift pulse shifted by the first shift resistor to the second shift resistor; and
selector circuits that change a channel through which a shift pulse is supplied from the first shift resistor to the third shift resistor and a channel through which a shift pulse is supplied from the third shift resistor to the second shift resistor,
wherein the first data line driving circuit stops driving the first data line based on a shift pulse shifted by the third shift resistor; and
wherein the second data line driving circuit starts driving the second data line based on a shift pulse shifted by the third shift resistor.

2. The display-driver data line driving device according to claim 1,
wherein each of the first to third shift resistors comprises cascaded data flip flops, each of the data flip flops comprising a data input terminal, a clock input terminal, and data output terminals and outputting a shift pulse supplied via the data input terminal from the data output terminals in synchronization with a clock supplied via the clock input terminal,
wherein the third shift resistor comprises a first data flip flop and a second data flip flop connected in a stage subsequent to the first data flip flop,
wherein the first data line driving circuit stops driving the first data line in synchronization with a shift pulse outputted from the second data flip flop, and
wherein the second data line driving circuit starts driving the second data line in synchronization with a shift pulse outputted from the first data flip flop.

3. The display-driver data line driving device according to claim 2, wherein the third shift resistor comprises a third data flip flop connected in a stage subsequent to the first data flip flop and prior to the second data flip flop, and a data output terminal of the third data flip flop is connected to the second shift resistor via the selector circuits.

4. The display-driver data line driving device according to claim 1, wherein the first data line driving circuit starts driving the first data line based on a start signal supplied as a shift pulse to an initial stage of the first shift resistor, and the second data line driving circuit stops driving the second data line based on a shift pulse outputted from a final stage of the second shift resistor.

5. A display-driver data line driving device comprising:
a first data line driving circuit that drives a first data line;
a first shift resistor;
a first display latch portion that is connected to the first data line and that receives a shift pulse shifted by the first shift resistor as a clock to latch data supplied via the first data line;
a second data line driving circuit that drives a second data line;
a second shift resistor;
a second display latch portion that is connected to the second data line and that receives a shift pulse shifted by the second shift resistor as a clock to latch data supplied via the second data line;
a first channel and a second channel that send a shift pulse shifted by the first shift resistor to the second shift resistor; and
selector circuits that select whether to input a shift pulse shifted by the first shift resistor to the second shift resistor via the first channel or the second channel,
wherein the first data line driving circuit stops driving the first data line after the first display latch portion latches data, and
wherein the second data line driving circuit starts driving the second data line before the second display latch portion latches data.

6. The display-driver data line driving device according to claim 5, wherein each of the first and second shift resistors comprises cascaded data flip flops, each of the data flip flops comprising a data input terminal, a clock input terminal, and data output terminals and outputting a shift pulse supplied via the data input terminal from the data output terminals in synchronization with a clock supplied via the clock input terminal
wherein the second data line driving circuit starts driving the second data line in synchronization with a shift pulse outputted from a data flip flop arranged in a stage prior to the selector circuits, and
wherein the first data line driving circuit stops driving the first data line in synchronization with a shift pulse that is further delayed by causing a data flip flop to shift a shift pulse supplied to the second shift resistor via the selector circuits.

7. The display-driver data line driving device according to claim 5, wherein the first data line driving circuit starts driving the first data line based on a start signal supplied as a shift pulse to an initial stage of the first shift resistor, and the second data line driving circuit stops driving the second data line based on a shift pulse outputted from a final stage of the second shift resistor.
